(19) United States
(12) Patent Application Publication
(10) Pub. No.: US 2026/0305857 A1
(43) Pub. Date: Oct. 8, 2026

(54) ANTI-FATIGUE MAT

(71) Applicant: LIVYI LLC, LOS ANGELES, CA (US)

(72) Inventor: Yi Zhang, Xiamen (CN)

(21) Appl. No.: 19/269,057

(22) Filed: Jul. 15, 2025

(30) Foreign Application Priority Data
Apr. 3, 2025 (CN) 202520627589.1

(51) Int. Cl. A47G 27/02; H05B 3/14; H05B 3/36

(52) U.S. Cl. CPC A47G 27/0231; H05B 3/145; H05B 3/36; H05B 2203/003; H05B 2203/013

(57) ABSTRACT

The present application relates to an anti-fatigue mat including a mat body, a heating layer and a controller, where the heating layer is disposed on the mat body, and the heating layer includes a heating element and a wiring layer for arranging the heating element. The heating element is evenly arranged on a side of the wiring layer facing the mat body. The controller is disposed at the wiring layer and is electrically connected to the heating element; and the controller includes a switch for controlling energization and de-energization of the heating element.

### TECHNICAL FIELD

The present application relates to the technical field of grounding mats, and in particular to an anti-fatigue mat.

### BACKGROUND

An existing anti-fatigue mat is mainly used to relieve foot and leg fatigue caused by standing for a long period of time. The anti-fatigue mat may improve blood circulation, reduce leg and foot pain, relieve fatigue, boost productivity, etc. However, the anti-fatigue mat itself will become hard during long-term use, and has deteriorated elasticity.

### SUMMARY

Disclosed is an anti-fatigue mat, including:
a mat body;
a heating layer disposed on the mat body, the heating layer including a heating element and a wiring layer for arranging the heating element, where the heating element is evenly arranged on a side of the wiring layer facing the mat body, and the heating element is embedded within the wiring layer or the heating element is attached to the wiring layer; and
a controller disposed at the wiring layer and electrically connected to the heating element, where the controller includes a switch for controlling energization and de-energization of the heating element.

### BRIEF DESCRIPTION OF THE DRAWINGS

In accompanying drawings, the same reference signs denote the same or similar components or elements throughout multiple drawings unless otherwise specified. These drawings are not necessarily drawn to scale. It should be understood that these drawings depict only some implementations according to the present application and should not be construed as limiting the scope of the present application.

FIG. 1 is a structural schematic perspective view of an anti-fatigue mat according to an embodiment of the present application;

FIG. 2 is a structural schematic exploded view of an anti-fatigue mat according to an embodiment of the present application;

FIG. 3 is a schematic diagram of a bent resistance wire for an anti-fatigue mat according to an embodiment of the present application;

FIG. 4 is a schematic diagram of a resistance wire being bent into a plurality of U-shaped structures according to an embodiment of the present application; and

FIG. 5 is a schematic diagram of an operation of a controller for an anti-fatigue mat according to an embodiment of the present application.

### LIST OF REFERENCE SIGNS

100. Anti-fatigue mat; 1. Mat body; 2. Heating layer; 21. Heating element; 211. Resistance wire; 2111. U-shaped structure; 22. Wiring layer; 3. Controller; 31. Switch; 4. Non-slip layer; 5. Temperature sensor; 6. Power cord.

### DETAILED DESCRIPTION OF EMBODIMENTS

Various different implementations or embodiments carrying out the subject matter and technical solutions are disclosed as follows. To simplify the disclosure, specific examples of elements and arrangements will be described below. Of course, these examples are merely exemplary, and are not intended to limit the scope of protection of the present application. For example, a first feature recorded later in the specification being formed above or over a second feature can include an implementation of forming a direct contact of the first and second features, and can also include an implementation of forming an additional feature between the first feature and the second feature such that the first and second features may not be in direct contact. In addition, reference numerals and/or letters may be repeated in different examples in the disclosure. This repetition is for the sake of brevity and clarity, and does not itself represent the relationship between the various implementations and/or structures to be discussed. Further, when a first element is described as being connected or coupled to a second element, the description includes an implementation in which the first and second elements are directly connected or coupled to each other, and also includes an implementation in which the first and second elements are indirectly connected or coupled to each other by using one or more other intervening elements.

Only some exemplary embodiments are briefly described below. As can be appreciated by those skilled in the art, modifications may be made to the described embodiments in various ways without departing from the spirit or scope of the present application. Therefore, the accompanying drawings and the description are considered as exemplary in nature rather than limiting.

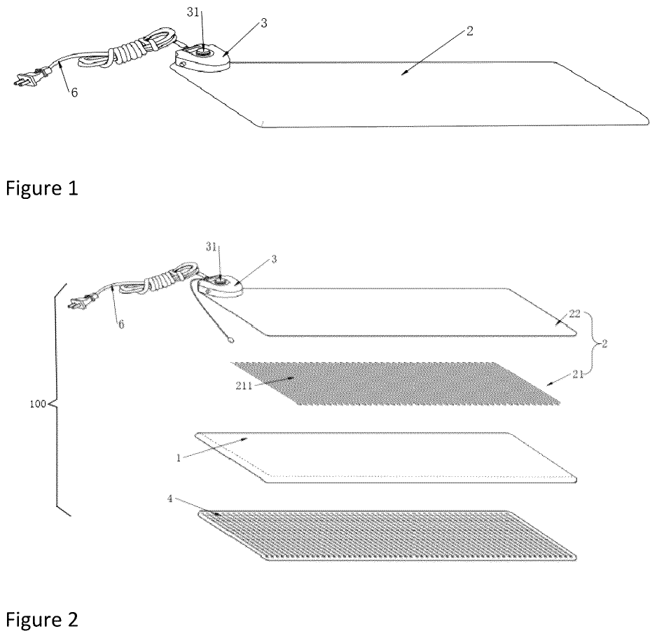

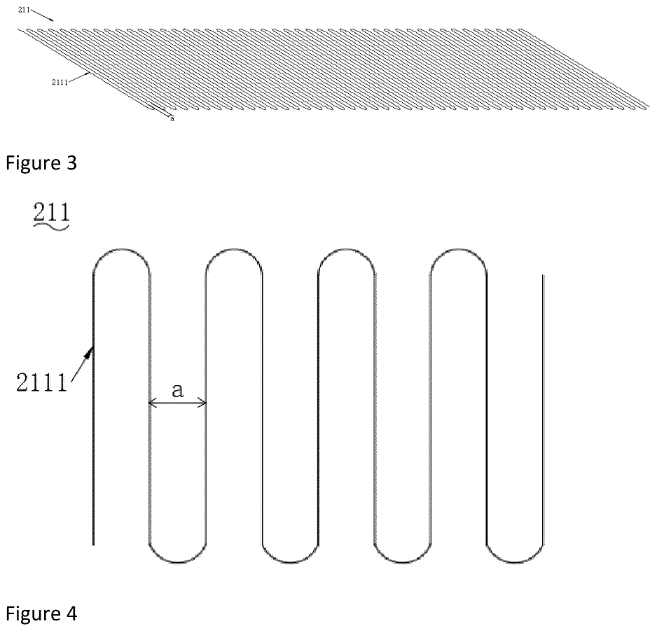

Referring to FIGS. 1 to 4, the present application provides an anti-fatigue mat 100 including a mat body 1, a heating layer 2 and a controller 3, where the heating layer 2 is disposed on the mat body 1, and the heating layer 2 includes a heating element 21 and a wiring layer 22 for arranging the heating element 21. The heating element 21 is evenly arranged on a side of the wiring layer 22 facing the mat body 1. The heating element 21 is embedded in the wiring layer 22, or the heating element 21 is attached to the wiring layer 22. The controller 3 is disposed at the wiring layer 22 and is electrically connected to the heating element 21; and the controller 3 includes a switch 31 connected to a power cord 6 for controlling energization and de-energization of the heating element 21. The switch 31 can be controlled by foot pedaling or manually. In this embodiment, by providing the heating layer 2 on the mat body 1, the mat body 1 becomes soft after being heated, thereby effectively preventing the anti-fatigue mat 100 from hardening, so that the anti-fatigue mat has good softness and elasticity even after long-term use, is conducive to improving blood circulation, enhances the user's leg and foot comfort, and increases the user experience. In some embodiments, a side of the wiring layer 22 for embedding the heating element 21 may be made of raw silicone (or referred to as virgin silicone), which is a highly active adsorbent material and is an amorphous material, and the main ingredient is silica. It is insoluble in water or any solvent, is non-toxic and odorless, and is chemically stable; and the raw silicone has a thickness within 2 mm for embedding the heating element 21. The thickness of the raw silicone is 0.1 mm, 0.3 mm, 0.5 mm, 1.5 mm or 2 mm, etc., which is not strictly limited here. In other embodiments, the wiring layer 22 may have a structure in which the raw silicone is embedded on both sides of glass fiber, or a structure in which the raw silicone and the cured silicone are embedded on both sides of the glass fiber, respectively.

In an embodiment, the mat body 1 is a composite made of one or more materials of polyurethane, rubber, foam, sponge, vinyl, polyvinyl chloride, gel, silicone, or wood. For example, the mat body 1 is made of pearl cotton, which has good rebound performance, and a user can get a better foot feel experience.

Referring to FIGS. 1 to 4, in an embodiment, the wiring layer 22 is made of silicone, rubber, sponge, polyurethane, polyvinyl chloride or other materials. The silicone material is soft, has good softness and resilience, can adapt to different surface shapes, and has good thermal conductivity, to ensure that the heat is evenly distributed. The silicone material also has an excellent electrical insulation property, which can be used safely in electronic devices, thereby preventing short circuits and other electrical problems. The silicone material is not only used for thermal conduction, but also has various functions such as shock absorption, sealing and insulation, abrasion resistance, and weather resistance, and can also meet the design requirements of ultra-thinning of the anti-fatigue mat 100.

Referring to FIGS. 1 to 4, in an embodiment, the thickness of the heating layer 2 is less than or equal to 5 mm, the heating layer 2 being thinner enables the mat body 1 to be more susceptible to deformation, and the user can get a better foot feel experience. When the thickness of the heating layer 2 is more than 5 mm, as the heating layer 2 is too thick, the deformation of the mat body is small when a pressure is applied to the mat body. Stepping on the anti-fatigue mat 100 does not achieve a good cushioning effect, which is not conducive to improving the user's blood circulation, and has a poor effect in relieving fatigue. At the same time, if the heating layer 2 is too thick, it is not conducive to the heat transfer of the heating element 21. It is difficult for temperature to be transferred to the surface, and the user cannot feel the temperature.

Referring to FIGS. 1 to 4, in an embodiment, the heating element 21 is an alloy resistance wire or a glass fiber resistance wire, and the resistance wire 211 has a diameter of less than or equal to 1.5 mm. For example, the diameter of the resistance wire 211 is 0.5 mm, 1 mm, 1.5 mm, etc. The resistance wire 211 is thin, so that the heating layer 2, which is covered with the resistance wire 211, is still soft and not too hard, and the mat body 1 is more prone to deformation, so that the user can get a better foot feel experience. If the diameter of the resistance wire 211 is greater than 1.5 mm, this will cause the heating layer 2 to be too hard. The anti-fatigue mat 100 is more difficult to produce large deformations when subjected to the pressure, and the user cannot obtain a good cushioning effect when stepping on the anti-fatigue mat, which is not conducive to improving the user's blood circulation, and has a poor effect in relieving fatigue. In addition, the diameter of the resistance wire 211 is greater than 1.5 mm, heat loss of a heating wire becomes large, and an energy efficiency ratio deteriorates.

Referring to FIGS. 1 to 4, in an embodiment, the resistance wire 211 is bent into a plurality of U-shaped structures 2111, the plurality of U-shaped structures 2111 are evenly arranged at intervals, and a spacing between adjacent U-shaped structures 2111 is less than or equal to 5 cm, the spacing being marked as a, where a ≤5 cm. For example, the value of a is 0.5 cm, 2 cm, 3 cm, 5 cm, etc. In this way, the resistance wire 211 is densely arranged, and also heats up evenly. In other embodiments, the heating element 21 is one of a carbon fiber heating wire or a graphene heating film. The routing follows the principle of uniform wiring of the resistance wire. It can be arranged in the shape of the Chinese character “ [symbol] ”, or can be routed laterally or vertically.

Referring to FIGS. 1 to 4, in an embodiment, the mat body 1 has a thickness of 0.02-5 cm. For example, the thickness of the mat body 1 is 0.02 cm, 1 cm, 2 cm, 3 cm, 4 cm, or 5 cm. When the thickness of the mat body 1 is less than 0.5 cm, stepping on the anti-fatigue mat 100 has the effect of causing discomfort to the feet. When the thickness of the mat body 1 exceeds 5 cm, the deformation of the mat body 1 under pressure is large, thus it is easy to stand unsteadily and does not facilitates improving the blood circulation of the user, the effect of relieving fatigue is relatively poor, and the mat body being too thick also increases costs. When the thickness of the mat body 1 is 0.5-5 cm, this thickness ensures that the mat body 1 is easily deformed after the mat body is under pressure, and the user can get a better foot feel experience.

Referring to FIGS. 1 to 4, in an embodiment, the anti-fatigue mat 100 further includes a non-slip layer 4 disposed on a side of the mat body 1 away from the heating layer 2, the mat body 1 being adhered to the non-slip layer 4 or the mat body 1 and the non-slip layer 4 being integrally formed. In other embodiments, a non-slip pattern is provided directly on a side of the mat body 1 away from the heating layer 2, and also has a non-slip effect.

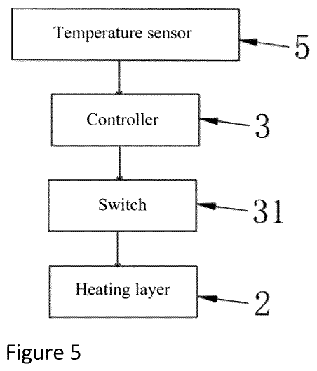

Referring to FIGS. 1 to 5, in an embodiment, the anti-fatigue mat 100 further includes a temperature sensor 5, where the temperature sensor 5 is disposed at the heating layer 2, and the temperature sensor 5 is electrically connected to the controller 3. The temperature sensor 5 detects the temperature of the heating layer 2 and transmits temperature data to the controller 3. When the temperature data reaches a set temperature value, the on and off of power supply is controlled by the switch 31 on the controller 3, thereby controlling the operating state of the heating layer 2. The temperature sensor 5 on the heating layer 2 is electrically connected to the controller 3, and the heating layer 2 operates when the temperature sensor 5 detects that the temperature of the heating layer 2 is below or within a set range; and the heating layer 2 stops working when the temperature sensor 5 detects that the temperature of the heating layer 2 is above the set range. Without frequent manual adjustment by the user, the controller 3, via the temperature sensor 5, automatically controls the surface temperature of the anti-fatigue mat 100 within a relatively constant range while providing overheat protection. In other embodiments, the controller 3 is provided with a timing device therein which allows an operating duration to be set for purposes of energy saving and safety. The controller 3 is further provided with a leakage protection device, which automatically cuts off the power supply if a person touches the anti-fatigue mat 100 by mistake when the anti-fatigue mat breaks and leaks electricity, so that the anti-fatigue mat 100 is safer to use.

The above technical solution has at least the following advantages or beneficial effects.

In the anti-fatigue mat 100 provided by the present application, by providing the heating layer 2 on the mat body 1, the mat body 1 becomes soft after being heated, thereby effectively preventing the anti-fatigue mat 100 from hardening, so that the anti-fatigue mat has good softness and elasticity even after long-term use, enhances the user's leg and foot comfort, and increases the user experience.

In the description of this specification, descriptions with reference to the terms such as “an embodiment”, “some embodiments”, “example”, “specific example”, or “some examples” mean that specific features, structures, materials, or characteristics described with reference to the embodiment or example are included in at least one embodiment or example of the present application. Moreover, the specific features, structures, materials or characteristics described can be combined in any one or more embodiments or examples in any suitable manner. In addition, without any contradiction, those skilled in the art may incorporate and combine different embodiments or examples and features of the different embodiments or examples described in this specification.

In addition, the terms “first” and “second” are merely used for the purpose of illustration, and cannot be construed as indicating or implying relative importance or implicitly indicating the number of technical features indicated. Thus, the features defined with “first” and “second” may explicitly or implicitly include at least one of the features. In the description of the present application, the meaning of “a plurality of” is two or more, unless explicitly and specifically defined otherwise.

The above description is merely specific implementations of the present application, but is not intended to limit the scope of protection of the present application. Any variation or replacement readily figured out by a person skilled in the art within the technical scope disclosed in the present application shall fall within the scope of protection of the present application. Therefore, the scope of protection of the present application shall be subject to the scope of protection of the claims. What is claimed is;

1-10. (canceled)

11. An anti-fatigue mat, comprising:
a mat body being a flexible material and having a thickness of 0.02 cm to 5 cm;
a heating layer disposed on the mat body, the heating layer having a thickness less than or equal to 5 mm and comprising a wiring layer and a heating element, wherein the wiring layer is a silicone material;
and wherein the heating element is a single, continuous resistance wire having a diameter less than or equal to 1.5 mm, and is fully embedded within the wiring layer such that the diameter of the resistance wire is less than a thickness of the wiring layer;
wherein the resistance wire is configured in a serpentine pattern along an extending direction to form a plurality of sequentially connected U-shaped segments that are evenly spaced apart, with a distance between any two adjacent U-shaped segments being less than or equal to 5 cm, and wherein the resistance wire lies within a single plane of the wiring layer without crossover or overlap; and
a controller disposed on the wiring layer and electrically connected to the heating element, the controller comprising a switch for controlling energization and de-energization of the heating element.

12. The anti-fatigue mat according to claim 11, wherein the resistance wire is an alloy resistance wire.

13. The anti-fatigue mat according to claim 11, wherein the resistance wire is a fiberglass resistance wire.

14. The anti-fatigue mat according to claim 11, wherein the mat body is a composite of one or more materials selected from the group consisting of polyurethane, rubber, foam, sponge, vinyl, polyvinyl chloride, gel, silicone, and wood.

15. The anti-fatigue mat according to claim 11, wherein the mat body is pearl cotton.

16. The anti-fatigue mat according to claim 11, further comprising a non-slip layer disposed on a side of the mat body opposite to the heating layer,

17. The anti-fatigue mat according to claim 11, wherein the non-slip layer is adhered to the mat body.

18. The anti-fatigue mat according to claim 11, wherein the non-slip layer and the mat body are integrally formed.

19. The anti-fatigue mat according to claim 11, further comprising a temperature sensor electrically connected to the controller.
